(19) United States
(12) Patent Application Publication
(10) Pub. No.: US 2014/0063415 A1
(43) Pub. Date: Mar. 6, 2014

(54) LIQUID CRYSTAL DISPLAY DEVICE

(71) Applicant: Japan Display Inc., Tokyo (JP)

(72) Inventor: Eiji OOHIRA, Mobara (JP)

(73) Assignee: Japan Display Inc., Tokyo (JP)

(21) Appl. No.: 14/010,700

(22) Filed: Aug. 27, 2013

(30) Foreign Application Priority Data
Aug. 30, 2012 (JP) 2012-189871

(51) Int. Cl. F21V 8/00

(52) U.S. Cl. CPC G02B 6/0091; G02B 6/0083
USPC 349/65

(57) ABSTRACT

In a liquid crystal display device, adjacent light-emitting elements of adjacent different groups are not connected in series but are arranged with an interval. Adjacent light-emitting elements of the same group are arranged with an interval shorter than the interval between the adjacent light-emitting elements of the adjacent different groups. The frame includes plural recesses recessed from an inner peripheral surface facing the light guide plate and recessed also from a surface opposite to the liquid crystal display panel. A protrusion is relatively formed between the adjacent recesses. The light-emitting elements of any one of the groups are housed in one of the recesses and the light-emitting elements of the plural groups are respectively housed in the plural recesses. A protrusion is positioned between the adjacent light-emitting elements of the adjacent different groups.

### CROSS-REFERENCE TO RELATED APPLICATION

The present application claims priority from Japanese application JP2012-189871 filed on Aug. 30, 2012, the content of which is hereby incorporated by reference into this application.

### BACKGROUND OF THE INVENTION

1. Field of the Invention

The present invention relates to a liquid crystal display device.

2. Description of the Related Art

A backlight of a liquid crystal display device includes a light guide plate for converting a point light source into a surface light source, and plural light-emitting elements are arranged in a line so as to face an end face of the light guide plate (JP 2010-62016A). Light emitted from the light-emitting element as the point light source is incident on the end face of the light guide plate, and outgoes to a liquid crystal display panel from the surface of the light guide plate by reflection. The light-emitting elements and the light guide plate are housed in a frame.

The frame to house the light-emitting elements and the light guide plate is fixed to the liquid crystal display panel and serves also as a reinforcing member. The frame includes plural recesses, and the light-emitting elements are respectively housed in the recesses. In the related art, since an interval between the adjacent light-emitting elements is wide, the plural recesses can be formed with a sufficient interval, and a part of the frame can be arranged as a wall between the adjacent light-emitting elements.

In recent years, the number of the mounted light-emitting elements increases because of a request for high brightness and high resolution, and adjacent light-emitting elements are provided to be close to each other. Thus, a wall can not be formed between the adjacent light-emitting elements, and there is a fear that the strength of the frame is reduced. The liquid crystal display panel becomes liable to be damaged by the reduction of the strength of the frame.

### SUMMARY OF THE INVENTION

The invention has an object to prevent damage of a liquid crystal display panel by suppressing reduction of strength of a frame.

(1) A liquid crystal display device of the invention includes a liquid crystal display panel and an edge light type backlight. The backlight includes a light guide plate arranged to overlap the liquid crystal display panel, plural light-emitting elements arranged in a line to face an end face of the light guide plate, and a frame that houses the light guide plate inside thereof and is attached to a peripheral edge of aback surface of the liquid crystal display panel. The plural light-emitting elements include plural groups of the light-emitting elements and each of the groups includes two or more light-emitting elements in which adjacent ones are connected in series. The adjacent light-emitting elements of the adjacent different groups are not connected in series but are arranged with an interval. The adjacent light-emitting elements of the same group are arranged with an interval shorter than the interval between the adjacent light-emitting elements of the adjacent different groups. The frame includes plural recesses recessed from an inner peripheral surface facing the light guide plate and recessed also from a surface opposite to the liquid crystal display panel. A protrusion is relatively formed between the adjacent recesses. The light-emitting elements of any one of the groups are housed in one of the recesses and the light-emitting elements of the plural groups are respectively housed in the plural recesses. The protrusion is positioned between the adjacent light-emitting elements of the adjacent different groups. According to the invention, since the protrusion is formed between the recesses in the frame, the reduction of strength of the frame is suppressed and the damage of the liquid crystal display panel can be prevented. Since the protrusion is formed between the light-emitting elements that are not connected in series and are arranged with an interval in order to avoid short circuit, the space can be effectively used.

(2) It is preferable that the liquid crystal display device recited in (1) further includes a flexible wiring board on which the plural light-emitting elements are mounted, and the flexible wiring board is superposed on the surface of the frame opposite to the liquid crystal panel.

(3) It is preferable that the liquid crystal display device recited in (2) further includes a double-sided tape to fix the flexible wiring board and the frame, and a part of the double-sided tape intervenes between the protrusion of the frame and the flexible wiring board.

(4) It is preferable that in the liquid crystal display device recited in (2) or (3), the flexible wiring board includes a wiring pattern electrically connected to the plural light-emitting elements, and the wiring pattern serially connects the light-emitting elements of each of the groups and does not serially connect the adjacent light-emitting elements of the adjacent different groups.

(5) It is preferable that in the liquid crystal display device recited in (1), the plural light-emitting elements are light-emitting diodes.

(6) A liquid crystal display device of the invention includes a liquid crystal display panel, a light guide plate facing the liquid crystal display panel, plural light-emitting elements facing an end face of the light guide plate, and a frame that houses the light guide plate and supports the liquid crystal display panel. The frame includes a first surface facing the end face of the light guide plate. The first surface includes plural recesses recessed in a direction of going away from the end face. The plural light-emitting elements are divided into plural groups. At least one of the plural groups includes plural ones of the plural light-emitting elements, and each of the plural groups is housed in each of the plural recesses.

(7) It is preferable that in the liquid crystal display device recited in (6), each of the plural groups includes plural light-emitting elements adjacent to each other with a first interval, the plural light-emitting elements include at least one pair of light-emitting elements adjacent with each other with a second interval and belonging to the groups different from each other, and the second interval is larger than the first interval.

(8) It is preferable that in the liquid crystal display device recited in (7), the plural light-emitting elements adjacent to each other with the first interval are connected in series, and the one pair of light-emitting elements are not connected in series.

(9) It is preferable that in the liquid crystal display device recited in (6), the plural light-emitting elements are arranged in a line, the plural groups include a first group including one light-emitting element, and plural second groups each including plural light-emitting elements adjacent to each other with a first interval, the light-emitting element of the first group is positioned at a center of the line and has a second interval from an adjacent light-emitting element, and the second interval is larger than the first interval.

(10) It is preferable that in the liquid crystal display device recited in (9), the plural light-emitting elements adjacent to each other with the first interval are connected in series.

(11) It is preferable that the liquid crystal display device recited in (6) further includes a flexible wiring board on which the plural light-emitting elements are mounted, the flexible wiring board is superposed on a surface of the frame opposite to the liquid crystal display panel, the flexible wiring board and the frame are fixed by an adhesive member, and a part of the adhesive member is arranged in an area between the plural recesses of the surface.

(12) It is preferable that in the liquid crystal display device recited in (11), the adhesive member is a double-sided tape.

(13) It is preferable that in the liquid crystal display device recited in (6), the plural light-emitting elements are light-emitting diodes.

### BRIEF DESCRIPTION OF THE DRAWINGS

FIG. 1 is a front surface view of a liquid crystal display device of an embodiment of the invention.

FIG. 2 is a back surface view of the liquid crystal display device of the embodiment of the invention.

FIG. 3 is a III-III line sectional view of the liquid crystal display device shown in FIG. 1.

FIG. 4 is a IV-IV line sectional view of the liquid crystal display device shown in FIG. 1.

FIG. 5 is a V-V line sectional view of the liquid crystal display device shown in FIG. 4.

FIG. 6 is a development view of a bent portion of a flexible wiring board of aback surface of the liquid crystal display device.

FIG. 7 is a view showing connection of plural light-emitting elements.

FIG. 8 is a view showing modified example 1 of the embodiment.

FIG. 9 is a view showing modified example 2 of the embodiment.

### DETAILED DESCRIPTION OF THE INVENTION

Hereinafter, an embodiment of the invention will be described with reference to the drawings.

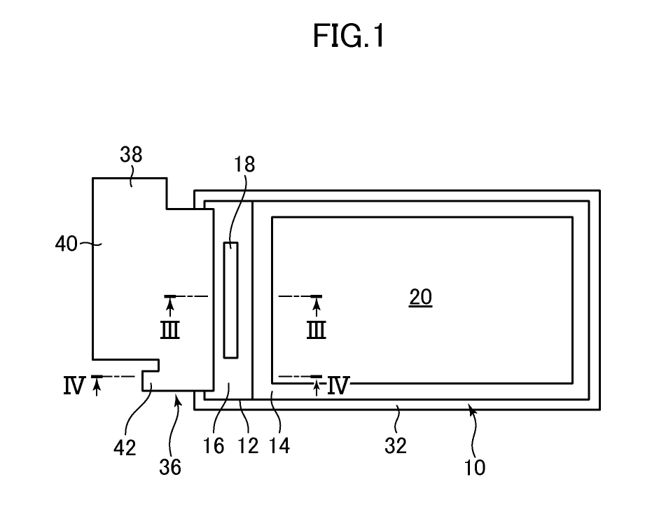

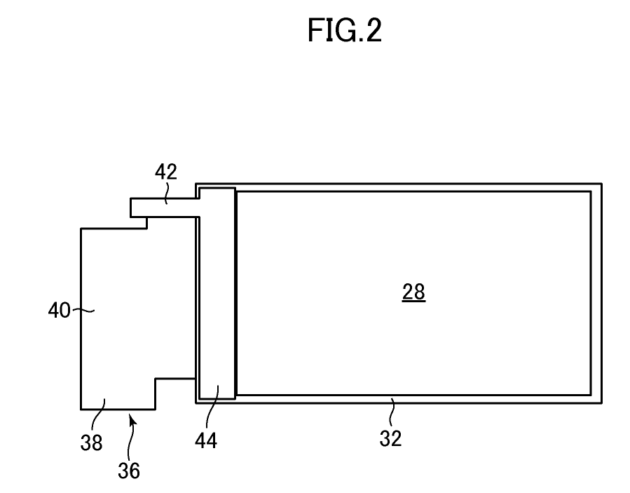

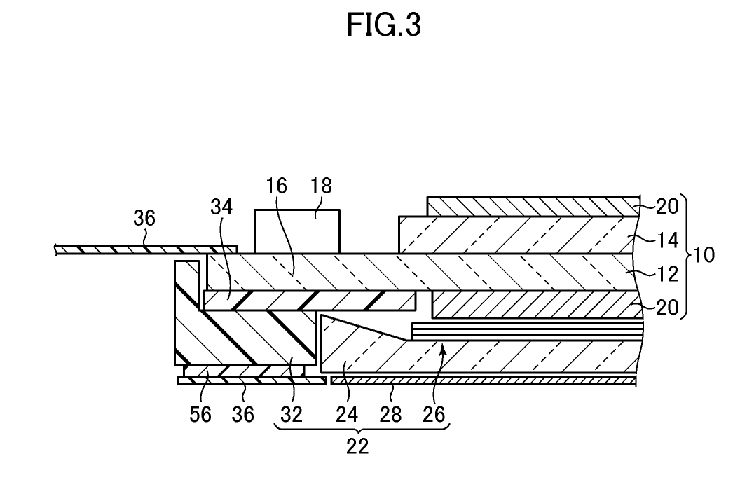

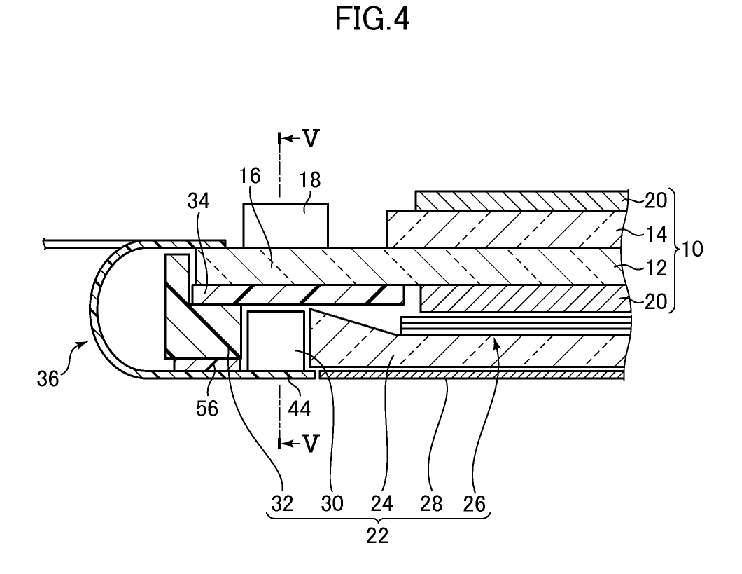

FIG. 1 is a front surface view of a liquid crystal display device of the embodiment of the invention. FIG. 2 is aback surface view of the liquid crystal display device of the embodiment of the invention. FIG. 3 is a III-III line sectional view of the liquid crystal display device shown in FIG. 1. FIG. 4 is a IV-IV line sectional view of the liquid crystal display device shown in FIG. 1.

The liquid crystal display device includes a liquid crystal display panel 10. The liquid crystal display panel 10 includes a pair of boards 12 and 14 (both are made of, for example, glass boards), and not-shown liquid crystal intervenes between both. The one board 12 is a TFT (Thin Film Transistor) board (or an array board) including not-shown thin film transistors, pixel electrodes, wiring and the like, and the other board 14 is a color filter board.

The one board 12 of the liquid crystal display panel 10 includes a protruding part 16 protruding relative to the other board 14. The liquid crystal display panel 10 (particularly the protruding part 16) is mounted with an integrated circuit chip 18 incorporating a driver circuit for driving the liquid crystal. A polarizing plate 20 is attached to each of the pair of boards 12 and 14 of the liquid crystal display panel 10.

The liquid crystal display device includes an edge light type backlight 22. The backlight 22 includes a light guide plate 24. The light guide plate 24 is arranged to overlap the liquid crystal display panel 10. A front surface of the light guide plate 24 faces a back surface of the liquid crystal display panel 10. The light guide plate 24 is arranged on the back surface side of the liquid crystal display panel 10 and to avoid a portion below the end of the liquid crystal display panel 10.

An optical sheet group 26 is arranged between the liquid crystal display panel 10 and the light guide plate 24. The optical sheet group 26 includes a diffusion sheet, a prism sheet and the like. Besides, a reflecting sheet 28 is arranged below the light guide plate 24 (opposite side to the optical sheet group 26).

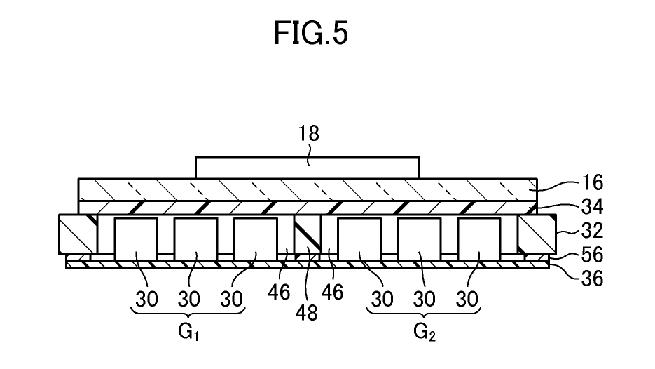

The backlight 22 includes plural light-emitting elements 30 (see FIG. 4). The light-emitting element 30 is, for example, a light-emitting diode. The light-emitting element 30 is a point light source for introducing light to the light guide plate 24. The light from the point light source is converted into a surface light source by the light guide plate 24, and is irradiated to the liquid crystal display panel 10. The plural light-emitting elements 30 are arranged in a line so as to face the end face of the light guide plate 24 (see FIG. 5).

The backlight 22 includes a frame 32 made of, for example, resin. The frame 32 houses the light guide plate 24 inside thereof. The liquid crystal display panel 10 is attached to the frame 32. The frame 32 has a frame-like shape, and the liquid crystal display panel 10 is attached to one surface of the frame so as to cover the inside space of the frame. The frame 32 is attached to the peripheral edge part of the back surface of the liquid crystal display panel 10. A light shielding double-sided tape 34 is used for the attachment. The end of the liquid crystal display panel 10 is supported by the frame 32 on the back surface side.

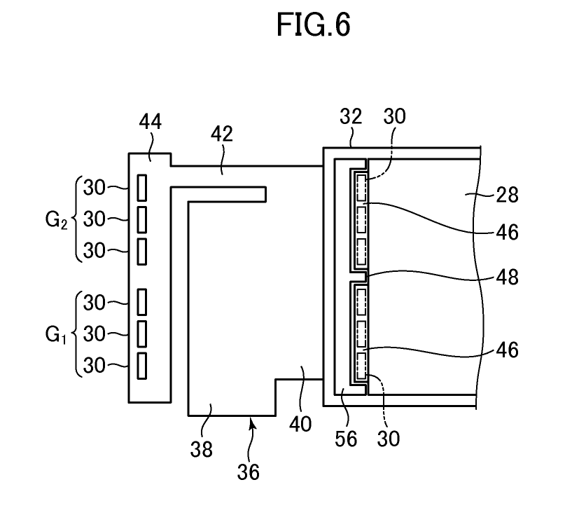

FIG. 5 is a V-V line sectional view of the liquid crystal display device shown in FIG. 4. FIG. 6 is a development view of a bent portion of a flexible wiring board of a back surface of the liquid crystal display device.

The plural light-emitting elements 30 are mounted on a flexible wiring board 36. The flexible wiring board 36 is bent and goes around from the display side surface of the liquid crystal display panel 10 to the back surface thereof. The flexible wiring board 36 includes a board 38 as shown in FIG. 6. The board 38 includes a main body part 40. A not-shown electric component is mounted on the main body part 40. The end of the main body part 40 is attached to the liquid crystal display panel 10 (particularly the protruding part 16) as shown in FIG. 1 and is electrically connected. The main body part 40 extends in the direction of separating from the liquid crystal display panel 10.

The board 38 includes an extension part 42. At a position deviated in the right or left direction along the width direction of the liquid crystal display panel 10, the extension part 42 extends from the main body part 40 toward the direction opposite to the end attached to the liquid crystal display panel 10.

The board 38 includes a component mounting part 44. The component mounting part 44 is positioned in the direction opposite to the end attached to the liquid crystal display panel 10. The component mounting part 44 extends along the width direction of the liquid crystal display panel 10. The length of the component mounting part 44 is the length in the right and left direction length along the width direction of the liquid crystal display panel 10. The width of the component mounting part 44 is the width in the direction orthogonal to the length of the component mounting part 44. The component mounting part 44 is connected to the extension part 42. The extension part 42 is shifted from the position opposite to the connection part to the main body part 40 and is connected to the component mounting part 44.

As shown in FIG. 4, the surface of the component mounting part 44 on which the light-emitting elements 30 are mounted is arranged to face the liquid crystal display panel 10. As shown in FIG. 6, the plural light-emitting elements 30 are arranged in a line along the length of the component mounting part 44.

As shown in FIG. 5 or FIG. 6, the frame 32 includes plural recesses 46 which are recessed from the inner peripheral surface facing the light guide plate 24 and are recessed also from the surface opposite to the liquid crystal display panel 10. A protrusion 48 is relatively formed between the adjacent recesses 46. The plural groups of the light-emitting elements 30 are respectively housed in the plural recesses 46.

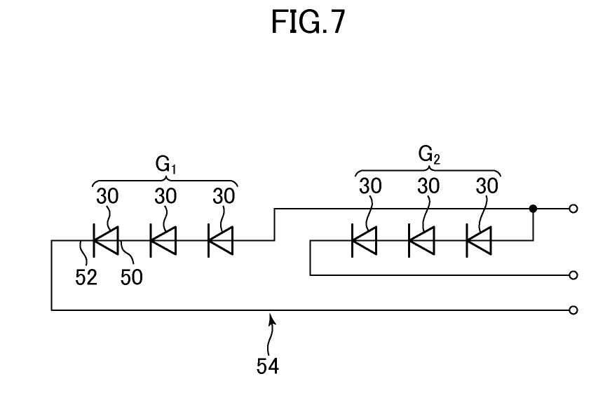

FIG. 7 is a view showing connection of the plural light-emitting elements. In FIG. 7, the light-emitting element 30 is indicated by a symbol of a diode. The light-emitting element 30 is, for example, a light-emitting diode (LED). The plural light-emitting elements 30 include the light-emitting elements 30 of plural groups G1 and G2. Each of the groups G1 and G2 includes two or more light-emitting elements 30, adjacent ones of which are connected in series. In the same group G1 or G2, an anode electrode 50 and a cathode electrode 52 of the adjacent light-emitting elements 30 are connected. The adjacent light-emitting elements 30 of the adjacent different groups G1 and G2 are not connected in series but are arranged with an interval. In the different groups G1 and G2, the anode electrode 50 and the cathode electrode 52 of the adjacent light-emitting elements 30 are not connected.

The flexible wiring board 36 includes a wiring pattern 54 electrically connected to the plural light-emitting elements 30. The wiring pattern 54 serially connects the light-emitting elements 30 of each of the groups G1 and G2. The wiring pattern 54 does not serially connect the adjacent light-emitting elements 30 of the adjacent different groups G1 and G2.

The adjacent light-emitting elements 30 of the same group G1 or G2 are arranged to be closer to each other than the adjacent light-emitting elements 30 of the adjacent different groups G1 and G2 (see FIG. 5 and FIG. 6). The light-emitting elements 30 of the one group G1 or G2 are housed in the one recess 46 of the frame 32. The protrusion 48 is positioned between the adjacent light-emitting elements 30 of the adjacent different groups G1 and G2.

The flexible wiring board 36 is superposed on the surface of the frame 32 opposite to the liquid crystal display panel 10. The flexible wiring board 36 and the frame 32 are fixed by a double-sided tape 56. A part of the double-sided tape 56 intervenes between the protrusion 48 of the frame 32 and the flexible wiring board 36.

According to this embodiment, in the frame 32, the protrusion 48 is formed between the recesses 46, and accordingly, the reduction of strength of the frame 32 is suppressed and the damage of the liquid crystal display panel 10 can be prevented. Since the protrusion 48 is formed between the light-emitting elements 30 which are not connected in series and are arranged with an interval in order to avoid short circuit, the space can be effectively used.

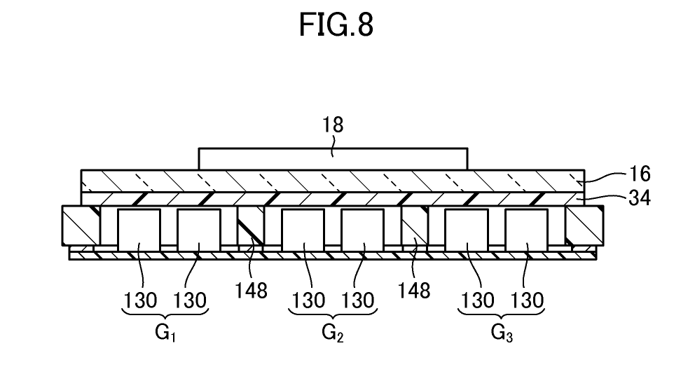

FIG. 8 is a view showing a modified example 1 of this embodiment. In the foregoing embodiment (see FIG. 5), although the plural light-emitting elements 30 are divided into the two groups G1 and G2, as shown in FIG. 8, plural light-emitting elements 130 may be divided into three groups G1, G2 and G3. In that case, a protrusion 148 is formed at two places.

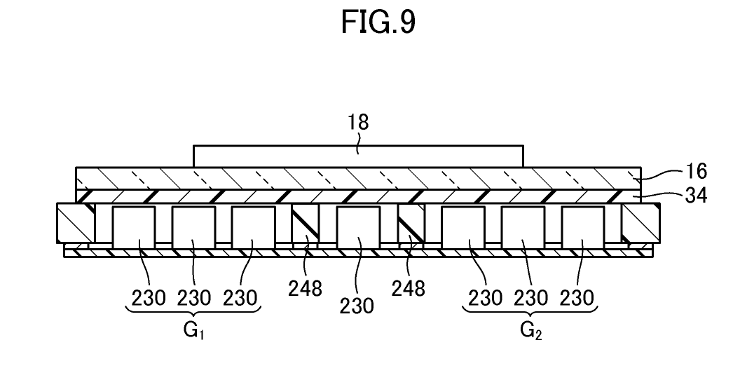

FIG. 9 is a view showing a modified example 2 of this embodiment. In the foregoing embodiment (see FIG. 5), an even number of light-emitting elements 30 are provided. On the other hand, in the example of FIG. 9, an odd number of light-emitting elements 230 are provided, and includes light-emitting elements 230 of plural groups G1 and G2 and one light-emitting element 230 not belonging to any group. Particularly, the one light-emitting element 230 not belonging to any group is arranged between the light-emitting elements 230 of the adjacent groups G1 and G2. Protrusions 248 are formed so as to sandwich the one light-emitting element 230 not belonging to any group.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
a liquid crystal display panel; and
an edge light type backlight, wherein
the backlight includes a light guide plate arranged to overlap the liquid crystal display panel, a plurality of light-emitting elements arranged in a line to face an end face of the light guide plate, and a frame that houses the light guide plate inside thereof and is attached to a peripheral edge of a back surface of the liquid crystal display panel,
the plurality of light-emitting elements include a plurality of groups of the light-emitting elements and each of the groups includes two or more light-emitting elements in which adjacent ones are connected in series,
adjacent light-emitting elements which belong to different groups out of the groups each other are not connected in series but are arranged with a first interval,
adjacent light-emitting elements which belong to the same group out of the groups are arranged with a second interval shorter than the first interval,
the frame includes a plurality of recesses recessed from an inner peripheral surface facing the light guide plate and recessed also from a surface opposite to the liquid crystal display panel, a protrusion is relatively formed between adjacent recesses out of the plurality of recesses,
the light-emitting elements of any one of the groups are housed in one of the recesses and the light-emitting elements of the plurality of groups are respectively housed in the plurality of recesses, and
the protrusion is positioned between the adjacent light-emitting elements which belong to different groups out of the groups each other.

2. The liquid crystal display device according to claim 1, further comprising a flexible wiring board on which the plurality of light-emitting elements are mounted, wherein
the flexible wiring board is superposed on the surface of the frame opposite to the liquid crystal panel.

3. The liquid crystal display device according to claim. 2, further comprising a double-sided tape to fix the flexible wiring board and the frame, wherein
a part of the double-sided tape intervenes between the protrusion of the frame and the flexible wiring board.

4. The liquid crystal display device according to claim 2, wherein
the flexible wiring board includes a wiring pattern electrically connected to the plurality of light-emitting elements, and
the wiring pattern serially connects the light-emitting elements of each of the groups and does not serially connect the adjacent light-emitting elements of the adjacent different groups.

5. The liquid crystal display device according to claim 1, wherein the plurality of light-emitting elements are light-emitting diodes.

6. A liquid crystal display device comprising:
a liquid crystal display panel;
a light guide plate facing the liquid crystal display panel;
a plurality of light-emitting elements facing an end face of the light guide plate; and
a frame that houses the light guide plate and supports the liquid crystal display panel, wherein
the frame includes a first surface facing the end face of the light guide plate,
the first surface includes a plurality of recesses recessed in a direction of going away from the end face,
the plurality of light-emitting elements are divided into a plurality of groups,
at least one of the plurality of groups includes ones of the plurality of light-emitting elements, and
each of the plurality of groups is housed in each of the plurality of recesses.

7. The liquid crystal display device according to claim 6, wherein
each of the plurality of groups includes ones of the plurality of light-emitting elements,
the ones are adjacent to each other with a first interval,
the plurality of light-emitting elements include at least one pair of light-emitting elements adjacent with each other with a second interval and belonging to the groups different from each other, and
the second interval is larger than the first interval.

8. The liquid crystal display device according to claim 7, wherein
the ones adjacent to each other with the first interval are connected in series, and
the one pair of light-emitting elements are not connected in series.

9. The liquid crystal display device according to claim 6, wherein
the plurality of light-emitting elements are arranged in a line,
the plurality of groups include a first group including one of the plurality of light-emitting elements, and a plurality of second groups each including ones of the plurality of light-emitting elements, the ones being adjacent to each other with a first interval,
the one of the first group is positioned at a center of the line and has a second interval from an adjacent light-emitting element, and
the second interval is larger than the first interval.

10. The liquid crystal display device according to claim 9, wherein the ones adjacent to each other with the first interval are connected in series.

11. The liquid crystal display device according to claim 6, further comprising a flexible wiring board on which the plurality of light-emitting elements are mounted, wherein
the flexible wiring board is superposed on a surface of the frame opposite to the liquid crystal display panel,
the surface has the plurality of recesses,
the flexible wiring board and the frame are fixed by an adhesive member, and
a part of the adhesive member faces the surface and is arranged in an area between the plurality of recesses.

12. The liquid crystal display device according to claim 11, wherein the adhesive member is a double-sided tape.

13. The liquid crystal display device according to claim 6, wherein the plurality of light-emitting elements are light-emitting diodes.
